(19) United States
(12) Patent Application Publication
(10) Pub. No.: US 2017/0061561 A1
(43) Pub. Date: Mar. 2, 2017

(54) MOBILE RIDE-SHARING SOCIAL NETWORKING E-COMMERCE PLATFORM

(71) Applicant: Steve CHA, Franklin Lakes, NJ (US)

(72) Inventor: Steve CHA, Franklin Lakes, NJ (US)

(21) Appl. No.: 15/235,760

(22) Filed: Aug. 12, 2016

Related U.S. Application Data
(60) Provisional application No. 62/209,584, filed on Aug. 25, 2015.

(51) Int. Cl. G06Q 50/30; H04W 4/02

(52) U.S. Cl. CPC G06Q 50/30; H04W 4/025; H04W 4/023

(57) ABSTRACT

The present disclosure relates to a mobile ride-sharing application which provides a social networking means that is conducive to its targeted demographic through its e-commerce platforming and method. Disclosed are a method providing a mobile ride-sharing application and an electronic device thereof.

### CLAIM OF PRIORITY

This application claims, pursuant to 35 USC 119, priority to, and the benefit of the earlier filing date of, that provisional patent application entitled “Mobile Ride-Sharing Social Networking E-Commerce Platform” filed in the U.S. Patent Office on Aug. 25, 2015 and afforded Ser. No. 62/209,584, the contents of which are incorporated the reference herein.

### TECHNICAL FIELD

The present disclosure relates to a mobile ride-sharing application which provides a social networking means that is conducive to its targeted demographic through its e-commerce platforming and method. Disclosed are a method providing a mobile ride-sharing application and an electronic device thereof.

### BACKGROUND

Field of the Invention

The present invention relates to a mobile ride-sharing application and in particular to a method of providing ride-sharing scheduling service and an electronic device thereof.

Background

### DESCRIPTION OF THE RELATED ART

A majority of an early child caregiver's day is spent on the road in the car. Commuting to school, after school sports, birthday parties, and recitals are all common areas where parents often travel for the sole purpose of benefiting their children. Often parents face many instances when they would need to rely on others to arrange transportation for their kids due to unexpected events. To this end, many parents typically rely on their friends, family members or peers in their kids' group when such a need arises. However, for those who cannot find a third party to assist them, there are not many options available. Further, parents and caregivers cannot rely upon the taxi industry or other ride-sharing entities because their environments are not suitable for transporting children. Most parents do not have enough trust in a taxi driver to pay him or her to transport their child to various activities. The taxi driver is unbeknownst to not only the parent but to the child as well. In addition, the fee to hire a taxi driver consistently to transport a child is costly and it takes time to call the cab company to arrive at a residential area is too much of an inconvenience that outweighs the potential benefits. Therefore, there is a need for an electronic device for providing more efficient and collaborative means to lessen the burden of parents and caregivers so that their time is not wasted on the road on a daily basis.

### SUMMARY

Whether it operates during either a planned agenda or a spontaneous outing, the present invention would enable users to collaborate with each other and use electronic devices to form an efficient yet suitable carpool experience for children during an emergency, in response to an unforeseeable event, or during a voluntary time in an effort to afford more time off for the parents or caregivers to attend other matters. This is achieved by putting a familiar and trustworthy face behind the wheel. Unlike other ride-sharing applications with e-commerce properties this platform does not claim that a user will be able to generate a significant net profit. There will, however, be other incentives including both monetary and non-monetary rewards amongst users. For example, a user can contribute to the well-being of the children directly by, for example, transferring rewards to their education, or by donating to a local charitable cause of choosing. Also, rewards can be selectively credited towards retail credit and stores. This helps remove the business aspect of carpooling and creates a community-based environment instead of a for-profit cause. However, it can provide some monetary rewards for those who actively participate in the ride sharing when some users are more on giving side. For example, other users can credit a few dollars to those who initiate a pick-up and drop-off.

Further, the platform according to the teaching of present invention helps parents avoid embarrassment and guilt when inquiring for help from other familiar friends or acquaintances. A user is able to noninvasively ask other friends from his/her contacts about potential carpool agreements. Many parents do not feel comfortable with even asking friends or neighbors for favors. This platform, therefore, is set up on an electronic device with consequential steps that aim to create a comfortable method of enabling parents to communicate with one another.

According to one aspect of the invention, the platform brings together, on an electronic device, all aspects of the necessary requirements that it takes to create a successful carpool agreement without becoming intrusive into personal matters by keeping all processes within the application. Parents do not have to spend time juggling with their social media, ridesharing, or e-commerce devices because all three services are combined into a singular platform on one electronic device. This takes the hassle and clutter out of the carpool planning in a parent's and/or caregiver's life that other industries and services do not necessarily provide.

According to another aspect of the invention, the aspect of charging a fee for a traditional car pool service is removed from this platform, and it instead promotes good samaritanship with added bonuses and rewards that benefit all parties mutually. In addition, this platform benefits surrounding local businesses by seamlessly incorporating them into the carpooling equation. Another aspect of carpooling, particular to road trips, is that parents may need to figure out the logistics of feeding and entertaining their children in a cost-efficient manner often times, an aspect not always thoroughly thought out when planning such trips. This platform covers an important aspect of a successful carpool that has traditionally needed to occur within another entity by bringing it into a singular stream of methodology on an electronic device.

According to another aspect of the invention, a user will be able to create a planned event via a home screen on an electronic device to plan a carpooling party. S/he will be able to set the payment, departure and return time, the location, and be able to select nearby local vendor deals and/or retail credit relative to their destination, as well as be able to select “roles,” such as guests, chaperones, and drivers. Once the host(s) and guest(s) have collaborated and met the requirements for approval for each required category their event will be published private and/or publicly where they will be given a receipt that shows all of the information input into the categories including: “payment, departure and return time, the location, and roles.” In addition, a time-sensitive unique discount code will be shown upon successful completion of a group for use in nearby affiliated vendor locations. A user can accomplish this all while keeping his/her party inclusive and private or public if s/he chooses to do so.

Upon initial startup the application will first ask a user to sign up either through a verified email account or synced Facebook account. In addition, a phone number will need to be verified via an SMS message sent to the listed phone number with a unique code that must be inputted during the setup startup. A user will be able to use either account as a login username and password once they have successfully logged in the other account. The application will also utilize basic information to sync his/her information and contacts with his/her new account and transfer his/her desired social circles. Upon successful synchronization a user will be able to view his/her friends' profiles, invite them to created events, send direct/group messages, and keep track of their transaction history. Only a user will be able to edit his/her profile page and a user may choose to privatize or publicize optional information. Every user will have a unique profile which other verified users that they have added may see. Synchronization systems will attempt to fill in most information that may be found in profile pages such as identification, status, favorite charities and/or causes, phone numbers, bank wiring numbers, and profile pictures. A phone number and an identification are the only required components of a profile picture. Throughout the entire application a user's profile page may be accessed, via an electronic device, so long as an icon with his/her profile is within the display of that particular page. This process will reroute them to said page, and a user may use the back button which will reroute him/her to the previous page.

As stated in paragraph [0009] a user will be able to view his/her friends' profiles. All users, including vendors, will have their individual personal accounts. Each profile will have basic information such as name, short biography, interests and hobbies, as well as categorized tagged industry “tags” for different industries for vendors. These interest and hobbies categories for regular users indicate categories of vendors based on what they frequently do with their children. For example, if a parent goes out with his/her child/children to movies frequently they can tag themselves with “Movies.” Likewise, s/he may also select other categories if they frequent “Sports” locations with their child/children. For vendors the categorized industry “tag” is a means to classify their business with the “interests and hobbies” of the regular users. Using an electronic device both vendors and parents may select up to three applicable categories which they may change at any time by accessing their personal profile. These vendors will only appear in the “Where?—Location & Deals” section of the menu depending on whether their categorized tag matches or is similar to that of the regular user. Users and vendors will be able to select their tag from a selection categories. In addition, a user will be able to request other categories if s/he feels their interest or hobby is not represented. The vendors can request other “tags.”

As stated in paragraph [0009] departure and return time are part of the requirements to have the event officially published. The departure time states the agreed-upon time of all parties at which to leave for the event. In this section the host can also describe the rendezvous point at which the party wishes to meet for departure if they choose to carpool together. The host can also choose to select different set time intervals for clarity and detail. For example, with this feature the host may be able to add a subset time interval at a rest stop at 1:00 PM even though the arrival at destination time is 3:00 PM. However, this is entirely separate from the “Where?-Location & Deals” section which is for the arrival destination. Once the host is satisfied with the time perimeters set, s/he may choose the “Ready” button, which will only become available once a plausible departure and return time have been established.

As stated in paragraph [0008] a user will be able to select his/her desired destination through a manual search by inputting the address with a visual map overlay to guide them in the “Where?—Location & Deals” section. Once s/he has selected that particular destination, nearby affiliated businesses will be displayed if their “tags” match what the host(s) or guest(s) are looking for. If the host(s) or guest(s) do not select or agree upon a desired additional venue to look for, the application will generate a list of nearby vendors according to the relative geographic location of their destination. Affiliated vendors will provide their addresses so that the server will know when to have them appear on the map. Their name and company picture will appear in this menu section if they are applicable and will be able to be selected by the regular users in order for the regular users to see their profiles. In addition, they will be able to view the deal they are advertising in the pop-up window in which their name and picture appear. These results will be generated at a set distance of 5 miles from the set location. All deals can only be validated using the time-sensitive code that carpooling parties are given if their event is successfully published.

As stated in paragraph [0009] a user will be able to direct/group-message people from his/her synced friend list in order to deliver other forms of informal communication and organization. This feature can be found in the main menu and by selecting the friend list and then selecting a messaging mode where the user will be able to search for their desired recipient and communicate via internet connection or mobile data service on an electronic device. By messaging another user a “conversation” chatroom will have been initiated with each party. If the party chat is only comprised of two users then the conversation will be disbanded if either party “leaves” via a button within the options menu of the conversation. If the party is comprised of more than two users then the conversation will only be disbanded if the host user is the only one left and decides to “disband” the conversation. The host user is not allowed to leave the conversation unless s/he is the last user. Additional users may be added into a conversation by any user already added.

As stated in paragraph [0009] a user will be able to, using an electronic device, keep track of his or her transaction history with at least one other user by selecting the “Rewards” section on the other user's profile. On that page each user will be able to see his or her mutual transaction history categorized by the most recent dates. In the window it will only display the amount, type of transaction, name of published event, and date. These transaction notifications cannot be tampered with in any way through editing or copying. This can be quickly assessed by a number showing the net amount a user has contributed to the other individual. For example when John Doe checks his transaction history with Allison Smith he may see “−3.00” whereas when Allison Smith checks her transaction history with John Doe she may see “+3.00” despite their transaction history with one another being the same.

As stated in paragraph [0009] a host will be able, using an electronic device, to request to issue roles to his or her guests whom will have the final say in whether they choose to accept or decline a request. A host will only be able to invite imported friends from his/her contact list. If a host wishes to add another participant that individual must be added onto a host's other social media platforms first and must have the same original application downloaded as well in order to participate. The host(s) can offer a wide variety of roles to their guest(s) or select certain types of roles for them. However, guest(s) can only accept roles once they have agreed to “attend” the event. Once a guest has agreed to join the event, s/he can preselect to offer to fill in a particular role. In that particular case, either a personal message will be sent to the host(s) or an automated message will be sent instead. An example of a message is: “John Doe is willing to be a chaperone at Allison Smith's Birthday—Accept or Decline.” If the host(s) may need help they can choose to write a personal message inquiring of their service or an automated message will be sent instead after selecting people from their friends list. For example, “Jane Smith is inquiring if you may chaperone at Allison Smith's Birthday—Accept or Decline.” Once the host feels all of the adequate spots are filled s/he may select the “Ready” button in that particular section.

As stated in paragraph [0009] a user will be able to select, using an electronic device, the type of payment s/he wishes to contribute or set for the carpool party. When a user accesses donation transactions that require third party platforms such as Paypal or Venmo s/he will be prompted to login through a pop-up portal within the original platform. Such login information may not be found on his/her profile page. However, bank wiring numbers, if inputted by the recipient, may be accessed for donating users. The creator of the event can pre-select his/her preferred donation cause such as the local school or charity. Invited guests are encouraged to contribute to the host's desired donation organization, and they are able to utilize the donation feature for other purposes as well including as a direct wiring/deposit to an individual or group and for purchasing gift cards in the payment menu.

As stated in the previous clause the transactions for gift cards will be conducted by the user by purchasing the gift card from the vendor directly via the Internet, and then the gift card code will be sent to the desired recipient through the platform. The transactions for direct wiring/deposit of currency to an individual or group will be conducted through other transaction platforms such as Paypal and Venmo. A user will have to either already have a pre-existing account or create a new account to utilize this feature. Once the user has a functioning Paypal and/or Venmo account s/he may transfer funds to his/her desired recipients while staying within the original platform on an electronic device. An Internet-based portal browser will open within the original platform on an electronic device instead of requiring the user to download a mobile-cellular version of either of said online payment applications.

A user executing this application may also select, using an electronic device, the quick-start button located on the home screen. Once s/he has selected the quick-start button a user will be asked to choose either “searching” or “driving.” A user who selects “searching” will be prompted to provide a simplified version of the “create an event” option, which will ask the user of the departure and name of trip, return time, location address, and rewards. Once s/he has completed those three steps s/he will be able to quickly publish his or her carpool request for other users to see, and will be in a “standby” mode waiting for another user to accept his/her request. The request will appear in a tile box along with other carpool requests from nearby users within a ten-mile radius. Another user will not be able to see the other user's location until both parties have agreed to carpool with one other. However, a user will be able to see the distance of the requester's location instead of the exact address for reference. Additional information in the tile box notification of requests include requested times or departure and arrival, estimated.

As stated in paragraph [0018] a user will be able to, using an electronic device, see other carpool requests. That user will be then able to choose whether to accept or decline another user's request by seeing tile icons that signifies their request. Interested users can select the requester's icon to open a detailed report of their inquiry. If the driver user chooses to accept the request s/he will have to wait for the requester to approve of them. A requester user can have multiple driver users and have up to five users in their waiting queue signifying those who have accepted their pending request. Once the standby user has selected one of the maximum of five user drivers both parties will be notified. The driver will be given the requester's address overlaid on a GPS map displayed on the electronic device via Wi-Fi or cellular data network. Upon completion of the inputted travel trip the agreed-upon bonus transaction will start.

As stated in paragraph [0018] when a user selects, on an electronic device, the quick-start menu from the home screen s/he will be prompted to either “searching” or “driving.” If the user selects “driving” as his/her option then s/he will be led to another set-up screen if s/he has not already met the criteria prior. A user will have submitted full disclosure of his or her personal information according to the requirements the federal and state law has set. Proof of legal and proper insurance must be provided as well as an automobile inspection and personal background check. Claim of proof of all of the stated requirements will be conducted outside of the platform. Once the user has been approved, the platform will enable the user driver to proceed into “driving mode.” Tile boxes of nearby users within a ten-mile radius will appear on the screens of their electronic devices. Driving mode users will be able to see the displayed information of: profile, departure and arrival time, destination address, and reward(s). As stated in paragraph [0019] once both users have informally as well as formally agreed to each other's terms through the method of the platform and personal judgement they may proceed to carpool.

The aspects, features and advantages of the present disclosure will be appreciated when considered with reference to the following description of examples and accompanying figures. The following description does not limit the application; rather, the scope of the disclosure is defined by the appended claims and equivalents.

### BRIEF DESCRIPTION OF DRAWINGS

FIG. 1 is a schematic diagram illustrating an example electronic network and server configuration of an electronic device in accordance with aspects of the present disclosure;

FIG. 2 is a schematic diagram illustrating an example electronic network and server configuration of an electronic device in accordance with aspects of the present disclosure;

FIG. 3 is a block diagram representing an example of a detailed event menu process executable in an electronic device in accordance with aspects of the present disclosure;

FIG. 4 is a block diagram representing an example of a quick start menu process executable in an electronic device in accordance with aspects of the present disclosure;

FIG. 5 is a block diagram representing an example of a payment process executable in an electronic device in accordance with aspects of the present disclosure;

FIG. 6 is a block diagram representing an example of a profile accessibility process executable in an electronic device in accordance with aspects of the present disclosure;

FIG. 7 is a flowchart representing an example of a quick start menu process executable in an electronic device in accordance with aspects of the present disclosure;

FIG. 8 is an illustration representing an example of information pane display screen(s) for an end-user interface of an electronic device in accordance with aspects of the present disclosure;

FIG. 9A is an illustration representing an example display screen for an end-user interface of an electronic device in accordance with other aspects of the present disclosure;

FIG. 9B is an illustration representing another example display screen for an end-user interface of an electronic device in accordance with other aspects of the present disclosure;

FIG. 10A is an illustration representing another example display screen for an end-user interface of an electronic device in accordance with other aspects of the present disclosure;

FIG. 10B is an illustration representing another example display screen for an end-user interface of an electronic device in accordance with other aspects of the present disclosure;

FIG. 11A is an illustration representing another example display screen for an end-user interface of an electronic device in accordance with other aspects of the present disclosure;

FIG. 11B is an illustration representing another example display screen for an end-user interface of an electronic device in accordance with other aspects of the present disclosure;

FIG. 12A is an illustration representing another example display screen for an end-user interface of an electronic device in accordance with other aspects of the present disclosure;

FIG. 12B is an illustration representing another example display screen for an end-user interface of an electronic device in accordance with other aspects of the present disclosure;

FIG. 13 is an illustration representing another example display screen for an end-user interface of an electronic device in accordance with other aspects of the present disclosure.

FIG. 14A is an illustration representing another embodiment of an electronic device where the users can collaborate carpooling;

FIG. 14B is an illustration demonstrating an exchange request for carpooling using an electronic device;

FIG. 14C is an illustration representing the ability of a user to provide a token of appreciation via an electronic device;

FIG. 14D is an illustration representing a requesting user making a request for carpooling using an electronic device, and another user confirming the offer using an electronic device; and

FIG. 15 is an illustration demonstrating users within a group exchanging emails/calls/texts using at least one electronic device.

### DETAILED DESCRIPTION

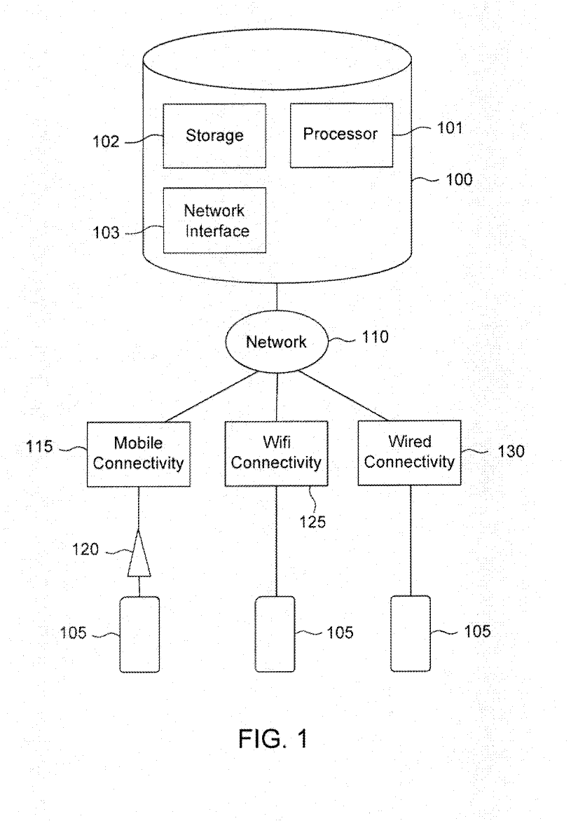

FIG. 1 is a schematic illustrating an example of an electronic server and network configuration of an electronic device in accordance with aspects of the present disclosure. In reference to FIG. 1 the announcement content server 100 may be utilized for storing, transmitting, and receiving information related to user-based announcements. These announcements can be received by a user requesting informational messages during a set period of time. These messages may contain, for example, promotions of other users looking or searching for a carpool, promotions by listed vendors who are relative to the geographic location of the destination, etc. In this particular instance a driving mode user may receive a message at 6:00 PM of another user within their vicinity needing a ride. At 6:05 PM the announcing user may need to change the destination. This process can be completed because these messages may be updated in real-time. That particular announcement posted by the host user may be updated selectively along with the modification to the text-based message itself in real-time.

In reference to FIG. 1 the announcements content server 100 can be housed with an electronic processing unit 101, a storage unit 102, and network interface 103 of an electronic device. The processing unit may facilitate the processing and execution commands of the machine instructions. The storage unit 102 used in the announcement content server 100 may utilize different computer memory storage. These different types of memory storage will enable both fast cache-based processing and standard long-term slower access storage depending upon the situation. The network interface 103 will relay communication through the network 110, where it can be configured to incorporate wireless network communication, and/or wired network communication by utilizing mobile/cellular data network, Bluetooth, near-field communication, Wi-Fi, etc.

In reference to FIG. 1 the announcement content server of the electronic device may also relay communication with portable and/or non-portable terminals 105. For instance, terminals 105 may represent smart phones, laptops and desktops, tablets, phablets, smart wearable devices, televisions, personal data assistants, displays, and any other unlisted portable and/or non-portable electronic device that may execute the invention described herein. Terminals 105 may relay communication through the announcement content server to internet 110 with several other connections. These may include either a mobile connectivity 115, wireless connectivity 125, and/or wired connectivity 130. Any means of connection for connecting to the announcements content server may be utilized and/or incorporated as required or needed.

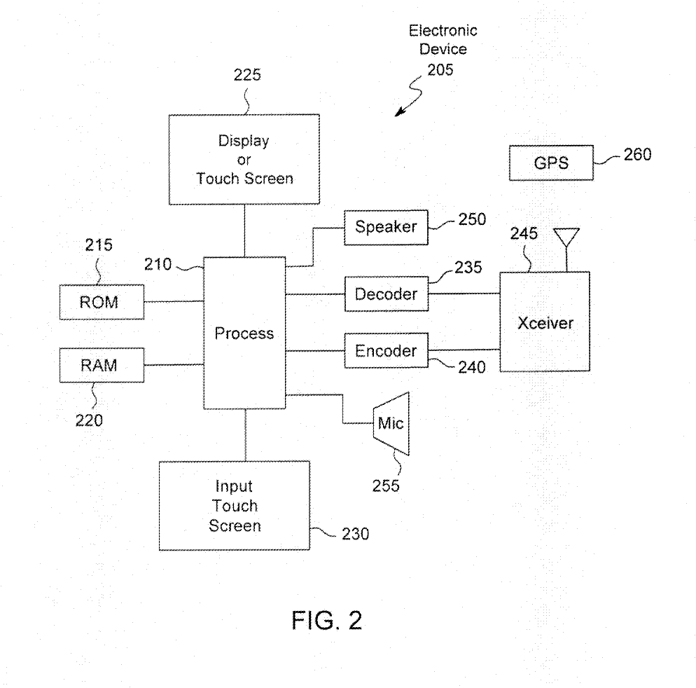

FIG. 2 represents a schematic diagram of an illustrative electronic device 205 for executing the techniques disclosed herein. Listed electronic device 205 may comprise of any of the described devices listed above (terminals 105) that are capable of transmitting data and processing instructions from device to another through connection such as 115, 125, and/or 130. However, the schematic diagram of electronic device 100 may or may not include all of the depicted components normally used in the connectivity process of an electronic device shown in FIG. 2. Despite this and for the purpose of this illustration, an example device 205 is listed.

In reference to FIG. 2 the example electronic device 205 may include a processor 210 that may be responsible for executing program instructions, performing calculations, and/or enabling the overall operation of applications. In device 205 a read-only memory unit may be utilized to provide storage memory for program instructions as well as data to be installed on the terminal 205 by the manufacturer such as an operating system or other required operations (and attendant requisite data). In addition, storage for user-selected programs from a mobile store, user media (pictures, music, and movies), and other assorted data will be stored in a random-access memory unit 220.

In reference to FIG. 2 a display unit 225 may be utilized for interfacing with the user through a configured display operation data with the electronic terminal 205. For a portable terminal user the display may comprise an “LCD,” “LED,” “OLED,” or “AMOLED” touch-screen, which may operate with a capacitive, resistive, acoustic, infrared, optical or dispersive signal touch-screen. In addition the touch-screen display can be also utilized to receive a variety of input information from the user depicted by input 230, for example an on-screen keyboard for inputting text. The display unit 225 may also comprise a traditional display for other conventional computing such as a laptop or desktop. In these non-touch screen electronic devices, input 230 may serve as a physical keyboard or keypad, an optical mouse device, stylus, or other combinations or forms of similar devices. However, touch-screen devices may also utilize stated physical devices and/or buttons for inputting data alone or in combination with the touch-screen of the electronic device.

In reference to FIG. 2 a decoder unit 235 and encoder unit 240 of the electronic device may be utilized to function to provide decoding and encoding to information that is transmitted and received by the electronic device 205 by the transceiver 245. The transceiver 245 will be utilized to communicate with other external devices and networks that may include, a Bluetooth unit, a wi-fi unit, a cellular communication unit, a near-field communication unit, a universal serial bus unit, a micro universal serial bus unit, etc. Therefore, the electronic device may incorporate as many communication units as needed or desired. In contrast to the illustration provided the transceiver 245 may manifest itself to be more than a singular unit.

In reference to FIG. 2 a speaker unit 250 may be utilized to convey output for sound frequency waves. Likewise, microphone unit 255 may be utilized for the input of sound frequency waves. The electronic device 250 may be equipped with more units than what is shown in the illustrated depiction and it can execute, for example, a cellular call if the device 205 were to be a smartphone. In addition it may, for instance, record sounds or playback audio media as well as aid in executing video calls.

In reference to FIG. 2 a global positioning system unit 260 may be utilized to aid location of the user terminal 205 when in the application there is a request to find the current location of the user terminal 205. For example, this may be useful when calibrating distance from another user who has posted an announcement in order to gauge travel time to find him/her.

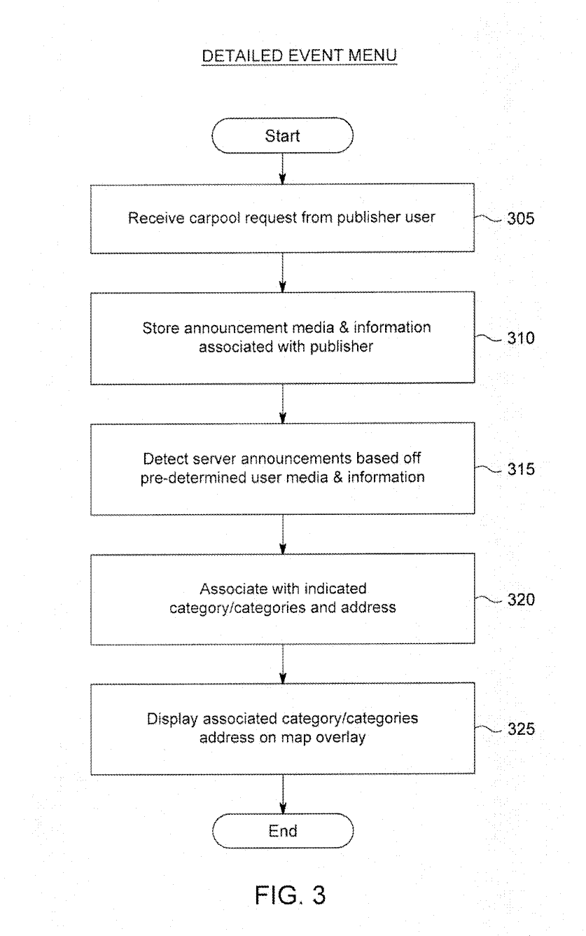

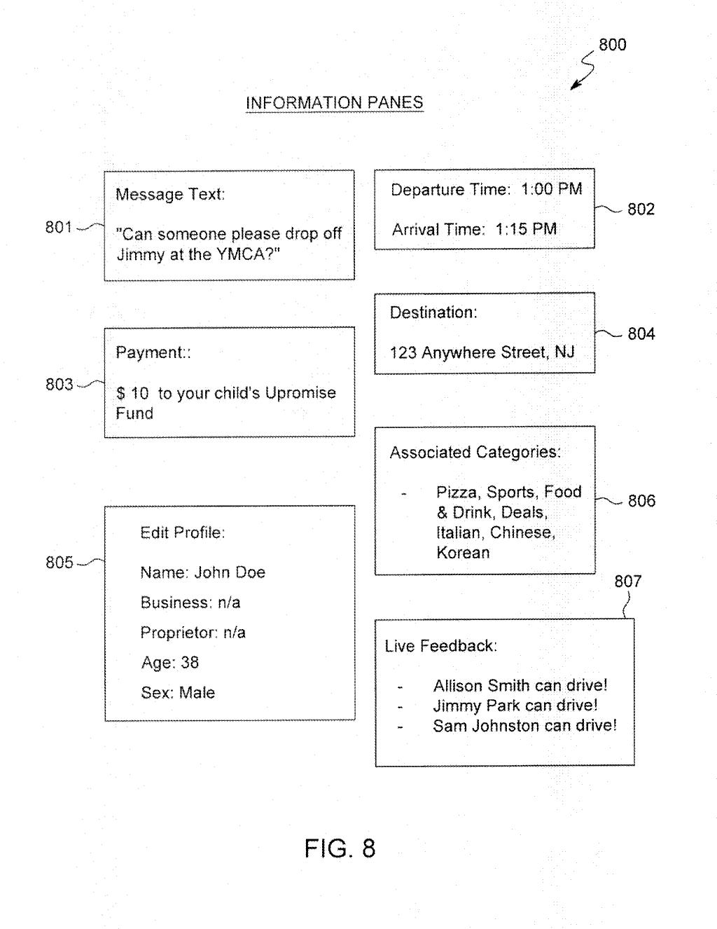

FIG. 3 is a flowchart illustrating the creation, via an electronic device, of a detailed carpool by a publisher user or a host. In step 300 the announcement content server may receive a request to generate a new announcement (for example, a host user generating a new announcement within the publisher user interface of FIG. 8). The request may be in tangent with, for instance, an announcement text entered into the publisher terminal via an on-screen keypad, and/or physical keyboard as well as keypad. In addition, the request made by the user terminal 205 may include one or more categories associated with the host user of the terminal 205 (such as Sports, Food, and Entertainment), and then associate the announcement with the account(s) of the vendor publisher user from whom the announcement was received.

In step 315 the categories are associated with the announcement depending on the publisher user and also in conjunction with any other additional category associations received with that particular request. If the host publisher user has several categories, they may indicate that all of the associated categories in the account are to be associated with the announcement. When the vendor publisher(s) has been associated with a host publisher user then they may use only a single address to be associated with their displayed representation, or a custom input address from the vendor publisher(s) may be used if he/she does not wish to use any of his/her existing establishments.

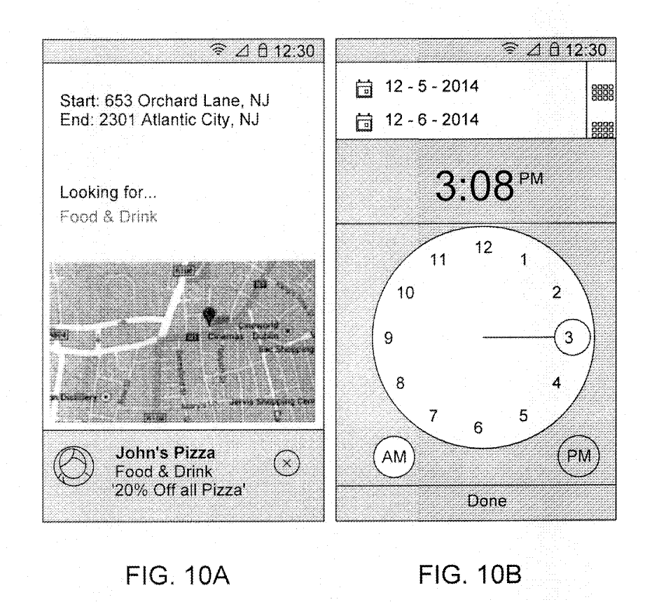

In step 325 the agenda for viewable publication of the announcement may be received or extrapolated from the request. The vendor publisher(s) also may indicate a time period for which the associated announcement is valid—for instance, the duration of a limited time promotional period. After the set time has expired the associated category/categories from the map overlay will disappear and can be replaced by a newly-stored announcement. If they do not indicate a time for expiration then the announcement will continue until they have either set a time limit or have uploaded a new announcement. This is illustrated in FIG. 10A, where “John's Pizza—20% off all Pizza” has no time limit and was displayed on the map overlay because the host publisher user and the vendor publisher user share the same category of “Food and Drink.” FIG. 10A is illustrative of the detailed event creation menu from the perspective of a host terminal user using an electronic device.

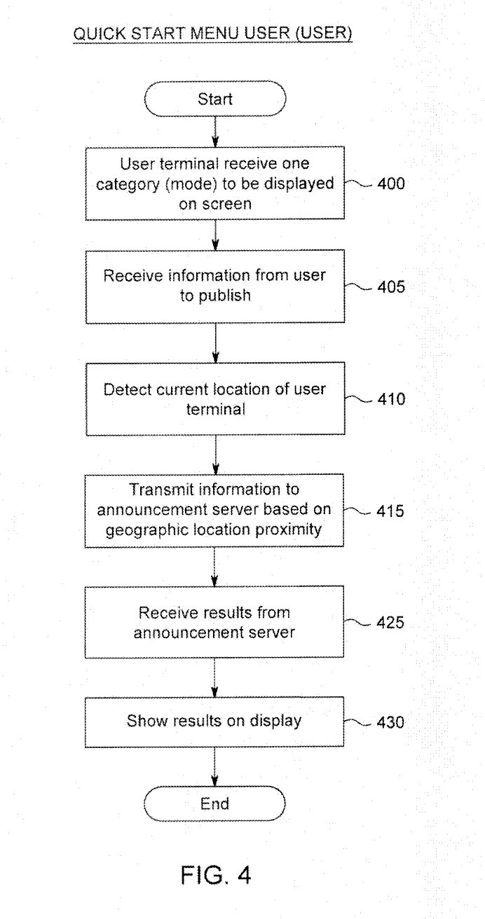

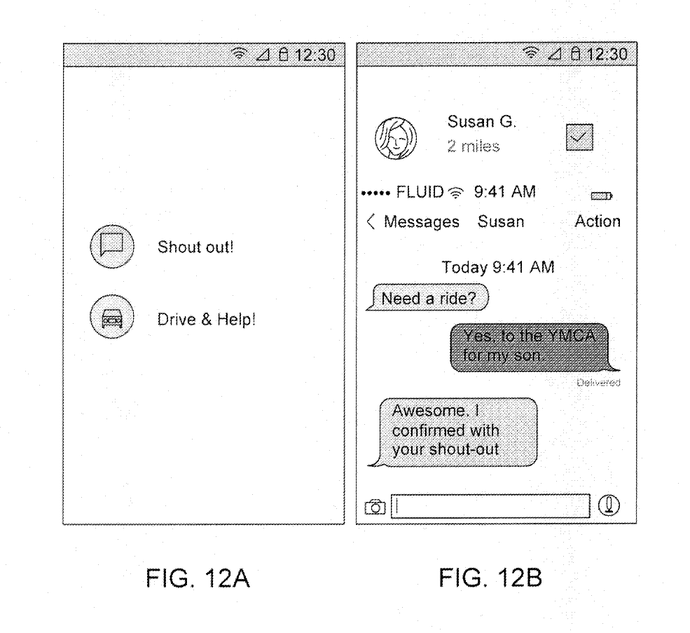

FIG. 4 is a flowchart representing an example of a sequence of steps taken via an electronic device for an end user terminal in the quick start menu searching for a driving user. In step 400 the end user terminal may receive from the end user only one selection of the two possible categories or modes from which will be displayed of the end user terminal element (e.g. via the first page of the quick start menu, FIG. 12A depicts two possible options only one of which can be chosen).

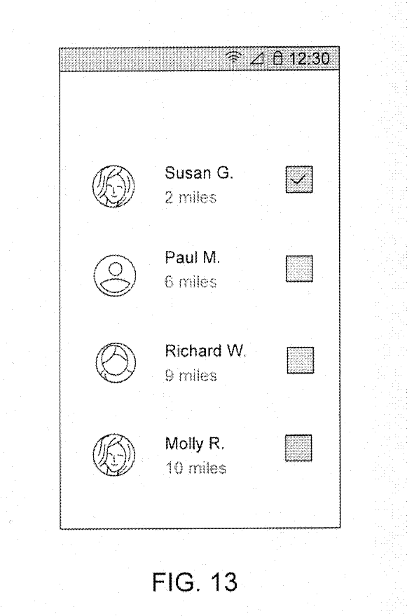

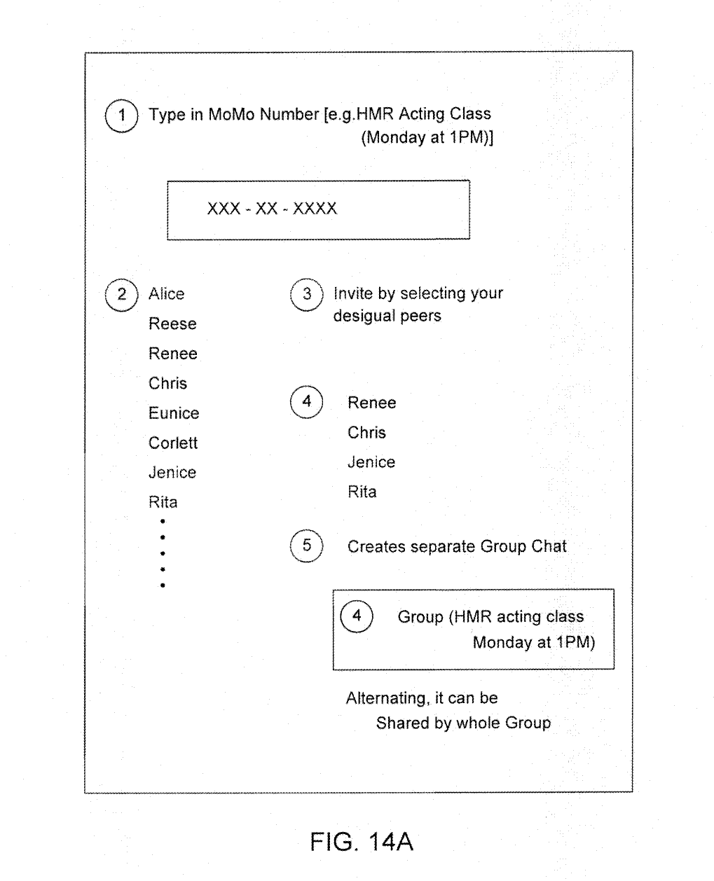

In step 405 the end user terminal may retrieve a current location based upon user connectivity, or find an end user designated location. The current location of the user terminal 205 may be claimed through a variety of methods including, for example, the GPS unit installed in the end user terminal, but other locating methods be utilized. For example, in order for the driving user to receive information that will approximate their distance from the announcing user the device can use wi-fi to locate the terminal if it is connected to a wi-fi network. During this step, the end user terminal may detect whether the standby screen (FIG. 8 and/or FIG. 13) is still open, which if it is, would indicate that the end user is viewing the notifications on the display. If the standby screen is still open, there is no need to update or change the announcement, and the sequence of steps may continue.

In step 410 the end user terminal may transmit the end user's location and geographic location distance to the announcement content server. This information may be broadcasted through several different mediums such as a base station (unit 115 of FIG. 1.), a wireless connection (unit 125 of FIG. 1), or a wired connection (unit 130 of FIG. 1). In FIG. 13 a depiction of Susan G.'s geographic location distance is shown to a nearby driver user terminal. However, the driver user terminal may not see the announcement user terminal's address until they have both agreed to carpool with one another.

In step 415 the end user terminal may receive announcement of carpool requests from other user terminals matching the transmitted relative geographic location. If the announcement contains media (such sounds, images, or video), the media in tangent with the message can also be received from the announcements content server at that time. Alternatively, if the media of a particular announcement message from a nearby user is to be displayed when it is selected by the end user, the media can be downloaded to the user terminal at the same time the announcement is selected, opened, or expanded. For example, media information that a user terminal could access at that particular time could be the user's profile page (Profile Pane FIG. 8, 805) where an image of their profile can be displayed to the user terminal.

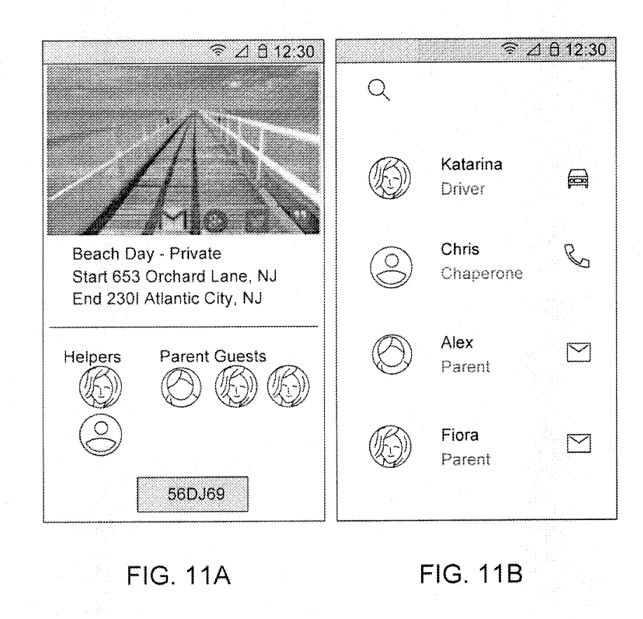

In step 430 the retrieved announcements from other user terminals seeking for a carpool may be displayed on a map on a display on an electronic device at the end user terminal once both have agreed to form a carpool party with one another. Once Susan G. has selected the green check mark, a carpool agreement will be asked to be confirmed by both parties. If either party declines even upon reaching the confirmation stage, the agreement will be invalidated, and both users will be brought to their original pages. The confirmation page will appear similar to that of FIG. 11A; however, “helpers,” “parent guests,” code, and sharing properties will be absent in the quick start feature. However, information panes such as the original message text 801, the departure and arrival time 802, payment 803, and destination 804 will be accessible and viewable in this page (FIG. 8). In addition, users will be able to communicate through voice calling via cellular network or wi-fi connection, as well as instant messaging as illustrated in FIG. 12B.

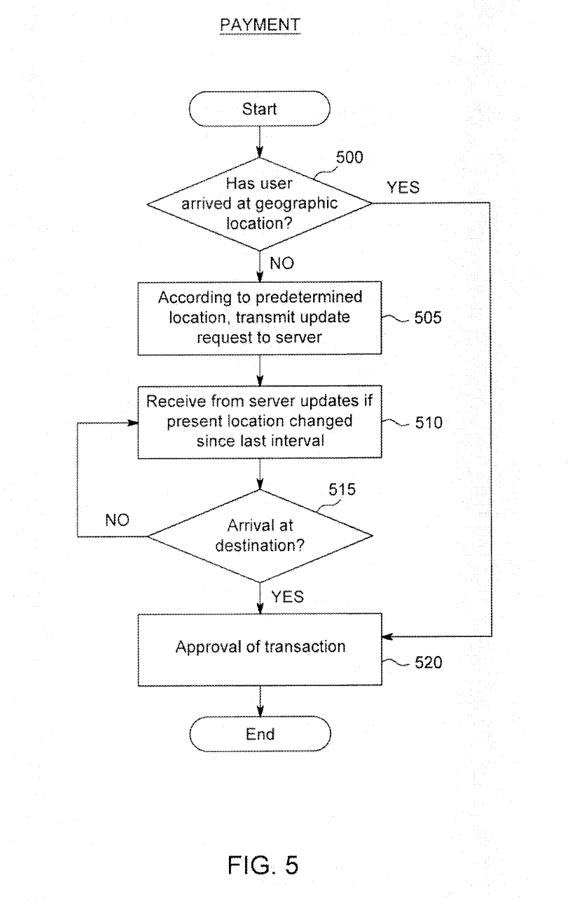

FIG. 5 is a flowchart representing an example of a sequence of steps, executed via an electronic device, for an end user terminal in the quick start menu searching for announcement users. As mentioned in paragraph [0057] during “this step, the end user terminal may detect whether the standby screen (FIG. 8 and/or FIG. 13) is still open, which would indicate that the end user is viewing the notifications on the display. If the standby screen is still open, there is no need to update or change the announcement, and the sequence of steps may continue.” In step 500 the end user terminal will receive request announcements including user information and distance. This resembles the live feedback pane 807 in FIG. 8.

In step 510, similar as in FIG. 13, an announcement user may see, displayed on his/her screen of an electronic device, nearby drivers. In this particular interpretation of FIG. 13, Susan G. is a nearby driver who has accepted the announcement user's request and a green check mark is therefore displayed on-screen. These announcements will only appear in the end user terminal's display if the announcements were detected within a similar geographic location and proximity. From there they may only select the detected announcements that are within their set geographic location and proximity. Afterwards, as described in clause [0060] if “either party declines even upon reaching the confirmation stage, the agreement will be invalidated, and both users will be brought to their original pages,” which would send them to an information pane similar to that of FIG. 11A with the same characteristics as those listed in paragraph [0060].

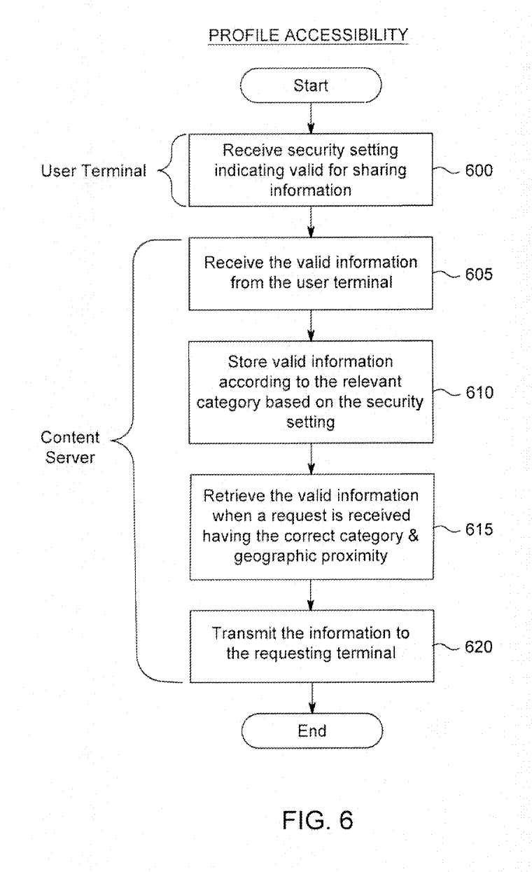

FIG. 6 is a flowchart representing an example of a sequence of steps, executed via an electronic device, for a payment transaction in both quick start and detailed event menus. After the event has been published and sent to the announcement content server for storage the transaction will be put on hold until the destination of the event has been reached by the recipient of the payment on that day. If the event is cancelled by the host then all transactions within the published event will become null and void from their “hold” stage of the transaction. In step 600 the end users may, at regular intervals, transmit an update request to the announcement content server with their location.

In step 610 the server will continue to send and request updates regarding the end user terminal's location until it has arrived at the geographic location of the destination. If the location of the destination has not been met, the server will continue to ask the end user for server updates since the last interval. Upon reaching the predetermined location, a transmit update request to the server will be sent so that the transaction of the payment on hold can be approved and sent to its valid recipients.

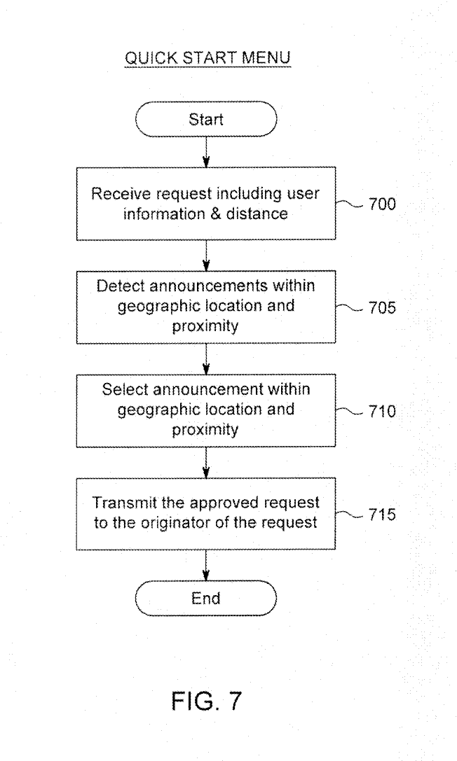

FIG. 7 is a flowchart representing an example of a sequence of steps, executed via an electronic device, for detailed profile accessibility through text or media. All user profiles will be downloaded and stored in the content server. A user will be able to access his/her profiles and the profiles of others by selecting either a name, text, or picture. In step 700 a user will receive a security setting indicating valid or invalid access to information. If the user is accessing or editing his/her information s/he may bypass the security setting for all of his/her information. If the user is accessing any profile aside from his/her own s/he must go through this step.

In step 705 if the user has requested for valid information his/her request will be sent to the content server to search for stored valid information according to the relevant category based on the security setting. When the valid information is retrieved it will be sent to the requesting user's terminal and will displayed on the screen of his/her electronic device. The requesting terminal may not change or alter the information it has received as it is only for viewing purposes. Information that can be displayed includes whether panes are similar, but not exact, to FIGS. 8, 805 and 806. Only added contact users may request information for profile-viewing from a particular user that they are already in tangent with.

FIG. 8 is an illustration of frequently-used information panes representing an example of display screen(s) of an electronic device for and end-user interface in accordance with aspects of the present disclosure. In information pane 801, a “message text” is shown that can be used, for example, for personal/group messages as well as title messages for carpool events. It can be edited and altered before publication when the information is utilized for the creation of an event, but not after it is published.

Information pane 802 indicates the usage “time” panel that can, for example, be used to indicate the past, present, future time of the end user terminal and the time for departure and arrival at a destination. It can be edited and altered before publication when the information is utilized for the creation of an event but not after it is published.

Information pane 803 indicates the usage of a “payment” panel that can, for example, be used to express the worth of a transaction. It can be edited and altered before publication when the information is utilized for creation of an event but not after it is published.

Information pane 804 indicates the usage of a “destination” panel that can, for example, be used to indicate the location of a user terminal or an address of an event. It can be edited and altered before publication when the information is utilized for the creation of an event but not after it is published.

Information pane 805 and 806 indicates the usage of a “profile” panel which can be used to express the detailed information of a user, entity, or other embodiment. It can be edited and altered depending on the security setting and ownership of the end user terminal requesting the information.

Information pane 807 indicates the usage of a “live feedback” panel which can be used to display live text-based messages accompanied by media such as images and sound to describe an event, message, etc.

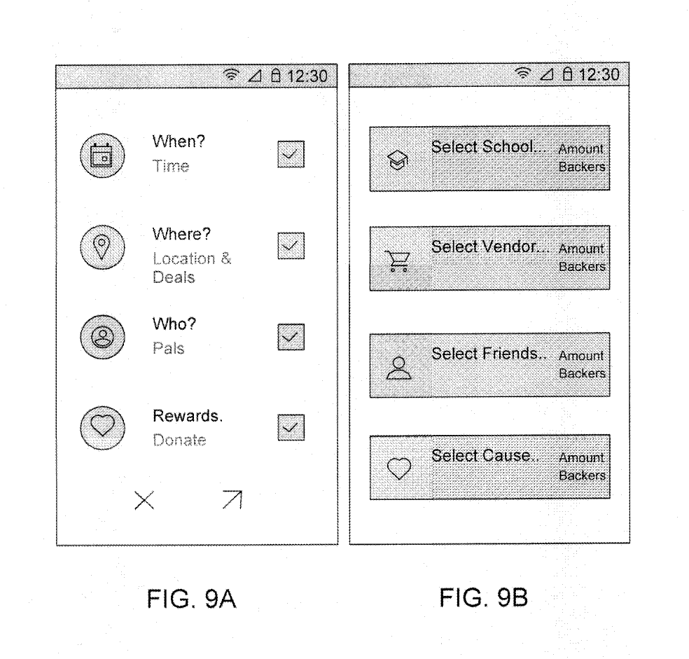

FIG. 9A is an illustration representing an example display screen of an electronic device configured to display an end-user interface for a general event creation menu. This menu is the first page an announcing user will be sent to if s/he wishes to use this feature. There are four categories that the end-user must complete in order to fulfill the requirements to store an event in the announcement content server. A user must complete the menu requirements in order from “When?,” to “Where?,” to “Who?,” to finally “Rewards.” As each category is completed with the required valid information, a signal of completion such as the illustrated green-checkmark will appear to signify the completion of that category. Thus, the user will not be allowed to move to the next category until s/he has completed all four. Once all the requirements have been met for valid announcement of an event, the user will be allowed to publish the event as illustrated by selecting the arrow button. Upon publication invites will be sent to the invited guests and payment will be charged but held until validation. Invited users or added users will be sent an invitation displaying all of the data and text inputted into the menu live before choosing to join or accept the carpool. The user may at any time exit and cancel the general event creation menu by selecting the x-mark button.

FIG. 9B is an illustration representing an example display screen of an electronic device configured to display an end-user interface for the general rewards configuration menu. The rewards configuration menu may usually be the last step the host end-user will access when creating an event. The host end-user will be able to pick from a panel featuring four total donation options: “School,” “Vendor,” “Friends,” and “Cause.” The “School” category is for organized public or private schools that qualify. The “Vendor” category is for small or franchise business e-gift cards. The variety of vendors from which the end-users may choose is predetermined. The “Friend” category is for direct wiring or transfer through e-commerce platforms such as Paypal, Venmo, or bank account to a particular user. The “Cause” category is for donations to other organizations, entities, or events that do not fall under the stated categories listed above. The host end-user may select any number of donation options for themselves and their guest users. However, at least one donation category must be selected followed by a minimal $6.00 USD transaction by the host-end user. Upon publication of an event, an additional user added or invited from either event menu may then choose from the selection of possible donation categories that the host end-user has chosen. Contribution is not required if s/he is an invited guest. Through a “live feedback” panel host end-users and guests users will be able to see, for each category selected, the total amount of donations and “backers” at that particular time. An invited user may choose to make his/her donation anonymously so that his/her profile is not displayed in the “backers” but his/her donated amount will still be displayed.

FIG. 10A is an illustration representing an example display screen of an electronic device configured to display an end-user interface for the “Where?” category of the general event creation menu. The host end-user must choose a valid start and end location for his/her event by inputting an address for both. Once a valid traveling route has been confirmed the results will be displayed overlaid on a map. Then the host end-user will be able to select for associated categories that relate to his/her event in the “Looking for.” tab of the page. Local vendors near the designated event location will appear on the overlaid map based upon their matching tags with the data inputted by the host end-user.

FIG. 10B is an illustration representing an example display screen of an electronic device configured to display an end-user interface for the “When?” category of the general event creation menu. The host end-user must input two sets of different types of data in order to create a valid time for their event. First, host end-user(s) must decide the starting and ending day of their event if the time scheduled requires different days. Then host end-user(s) must select the time of departure and arrival for their event. If additional times or days are necessary for a coherent carpool trip then the host end-user may select extra times or days to add that may represent, for example, rest stops for extended trips, etc.

FIG. 11A is an illustration representing an example display screen of an electronic device configured to display an end-user interface for the published announcement page. After all requirements have been met for the general event creation menu a user will be able to publish his/her event from the announcement content server from which the invited or added guests will be able to see live updates and changes made by, per se, the host end-user. All inputted data from the host end-user, including any modification or changes, will appear on this page. Invited guests as well as added guests will be able to see, via an electronic device, this page updated live. Within this page the unique generated discount code for nearby vendors will be listed as well. Codes are unique to the pages—therefore cancellation of event will cancel the validity of the code.

FIG. 11B is an illustration representing an example display screen of an electronic device configured to display an end-user interface for the roles of invited and/or added guests. Host end-users may request that a certain user or users fulfill particular roles upon receiving an invitation from the host. For example, a backup driver or chaperone role can be assigned to an individual. These roles may be accepted or declined. If an invited guest user decides to decline a role requested of him or her s/he will become a generic guest (as indicated by invite-mail symbol). The host-user may request invited guests again for role fulfillment if s/he chooses to do so. There is no requirement for a certain number or specific role to be filled in order for the announced event to be either validated or invalidated. It serves as an optional organizational tool for users to better coordinate their event. If the host user feels that there is a role that is not within the provided selection (e.g. backup driver, chaperone) then they may add additional roles by selecting the “other role” category.

FIG. 12A. is an illustration representing an example display screen of an electronic device configured to display an end-user interface for the quick-start menu. A user may select the quick-start menu for a streamlined and quick approach for his/her carpooling needs. A requesting user would select “Shout out!” while a driving user would select “Drive and Help!” When either page is selected s/he will be brought to a request or search for nearby friends or public users from their end terminals. For instance, a requesting user can request for particular friends to drive him/her or for their request to be received by nearby users. A driving user may search for nearby friends who are in need of a ride or can instead choose to search for public users. For both driving users and requesting users their preference for friends or other public users can be toggled “on” or “off” for a particular preference or both.

FIG. 12B is an illustration representing an example display screen of an electronic device configured to display an end-user interface for messaging between users. A user will be able to message other users whom s/he has invited or added from his/her friends list. Additional users from the friends list may be added (refer to [0013] for generic message user interface and functionality). Public users that are not from the requesting user's friend list may be messaged or called only from within that carpool menu. A user may also access other messages by selecting the “messages” button. If a user is in either the quick-start or detailed menu options s/he will be taken back to the general messenger function. A user will see, displayed on an electronic device, user full name, picture, message text, different colored bubbles to signify whom the message belongs to, and timestamps for reference.

FIG. 13 is an illustration representing an example display screen of an electronic device configured to display an end-user interface for the requesting or searching function for the quick-start menu. When either a requesting or driving user is pinging for friends or public users s/he will be both brought to a screen featuring separate live-feedback tiles with other users within his/her vicinity that fit their request or search. Once s/he has chosen a particular friend or public user (as indicated by the green check-mark button by his/her profile picture) s/he will be able to communicate with him/her while also being able to see disclosed information such as pickup location (refer to [0018] for complete list of disclosed information). The live-feedback pane of an individual user may display their profile picture, full name, and relative distance of user from which other users can see immediately. However, if a user wishes to see additional information from either the requesting user or the searching driver then s/he may select the user's profile picture for disclosable information (refer to [0018] for complete list of disclosed information).

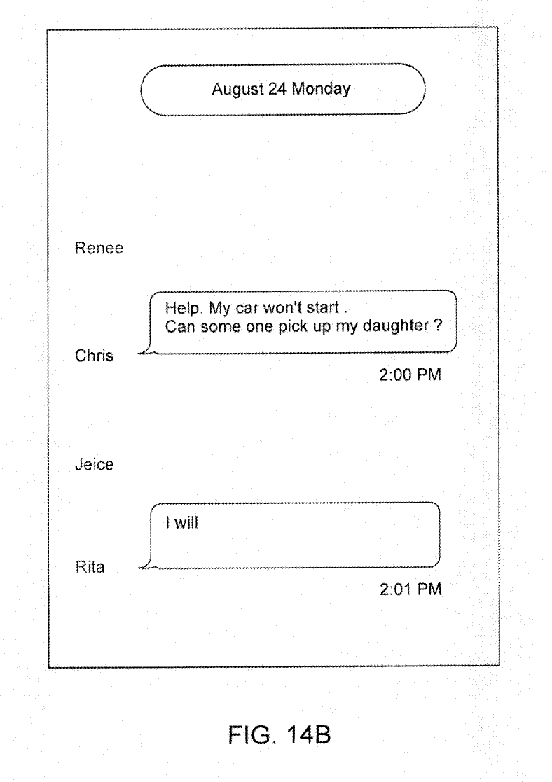

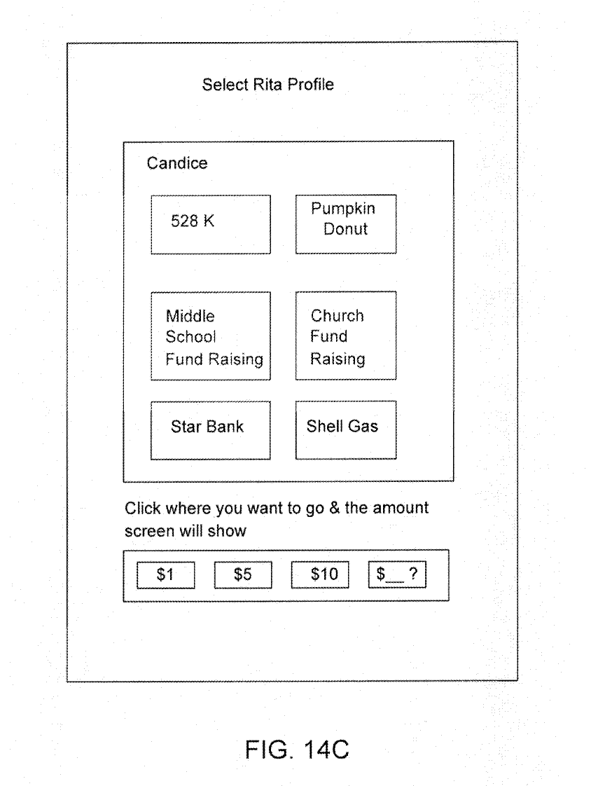

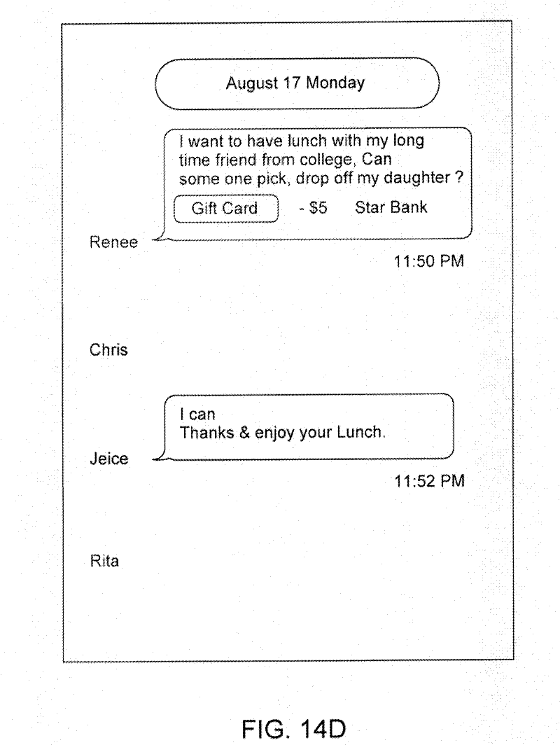

FIG. 14A is an illustration representing another embodiment of an electronic device demonstrating the ability of users to coordinate carpooling. First, a vendor or a person generates a “MoMo” (short for mothers on the go) reference number to group a number of parents. For example, an instructor in a given acting class can provide a MoMo reference number preassigned to Monday acting class at 1 pm. To this end, the instructor has to go to a site to generate this reference number and reserve the number for a finite period. The instructor can share this MoMo number with all the parents in the same class on the first day, for example. Parents can voluntarily log into this particular number (as shown in item 1 of FIG. 14A) and when they do, they can access other parents' contact information and collaborate to carpool when needed. Note that by generating a MoMo reference number for the parties to participate in the carpooling it eliminates the need to manually exchange information amongst parents in the same class. Further, even when the parties do not want to participate in the carpooling, the MoMo number can be used to gain access to other parents' contact information.

Alternatively, any one member of parent peers can generate a MoMo reference number and share the number with others to enable participation for the same purpose.

When parties log in with the MoMo number, which can be stored for later for easier access without retyping the number, the phone display will show and display names and/or profiles of other parents or peers in the same group or class. If a user has previously created a profile an icon representative of his/her profile will be display, or if not, it can be displayed as a guest. As shown in item 2 of FIG. 14A, a number of parents who log into the generated MoMo number can see other members.

As shown by item 3 any user shown can, via an electronic device, invite a number of other users displayed for carpooling. For example, one user may prefer carpooling with other users who live very close to his or her house or town so that it will be less burdensome and less intrusive to request a favor. To this end, as shown in item 4, one user can select only a few users in the group which in turn would create an email profile so that only those selected people can exchange emails between them. Alternatively a user has an option of group-chatting with all the users shown in item 2 for carpooling.

As shown in FIG. 14B once a group chat exchange occurs, users in the group can exchange, using at least one electronic device, requests for carpooling. After confirming a carpooling exchange, a requesting user can select the volunteer user to provide, using an electronic device, a token of appreciation as shown in FIG. 14C. A display of desired items will be shown via an electronic device and, once selected, the requesting user can add a desired amount.

Alternatively, as shown in FIG. 14D, a requesting user using an electronic device can post the amount or credit upon making a request for carpooling, and another user using an electronic device can confirm and accept the offer. To this end, a recipient user can simply click a gift card icon for $5 at Starbucks, or after the confirmation, the requesting user can apply the credit to the recipient user as demonstrated in FIG. 14C.

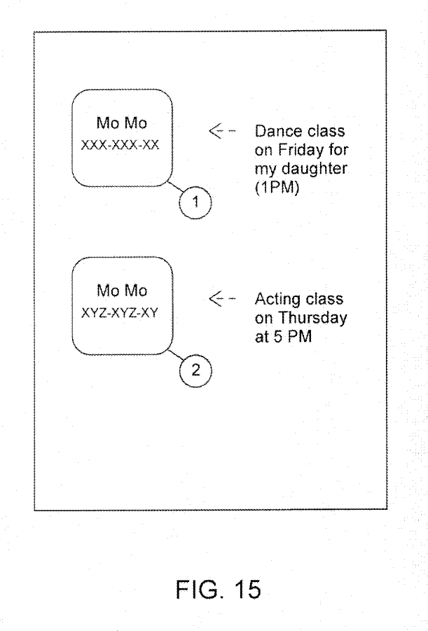

As shown in FIG. 15, once all the users are on board and registered to a particular number as explained with reference to FIG. 14, the system will enable all the users within the same group to exchange emails/calls/texts using at least one electronic device. If someone sends a request, a user can be notified. As such, for example, a parent can have a few icons displayed in his/her phone to represent different activities in which his/her kids participate, and s/he can exchange messages amongst his/her peers in the respective group in real time.

As is apparent from the foregoing, the present invention has an advantage in that parents or caregivers can check the availability of other peers during their children's activities and selectively make a request and arrange a carpool to lessen the daily burden of providing a ride to their kids. By efficiently collaborating with other peers, parents and caregivers can help each other whether it is during an unforeseeable emergency event or in order to tend to other matters. Hence, by collaborating using a user-friendly interface on an electronic device for requesting or searching help, parents and caregivers can be provided with the extra help they need during a daily grind of transporting their kids.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for.”

In addition, an artisan understands and appreciates that a “processor” or “microprocessor” constitutes hardware in the claimed invention. Under the broadest reasonable interpretation, the appended claims constitute statutory subject matter in compliance with 35 U.S.C. §101. The functions and process steps herein may be performed automatically or wholly or partially in response to user command. An activity (including a step) performed automatically is performed in response to executable instruction or device operation without user direct initiation of the activity.

The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

An electronic device may include a memory. The memory may include a program storing unit configured to store a program which controls an operation of the electronic device and a data storing unit configured to store data items generated while a program is executed. For example, the program storing unit may include an Operating System (OS) module, a communication module, a graphic module, a user interface module, a camera module, at least one application module, and a multimedia contents providing module. The modules included in the program storing unit may be expressed in a set of instructions. Also, the modules are expressed in an instruction set or programs.

The OS module may be configured to include at least one software component configured to control a general system operation. Also, the OS module may be configured to perform at least one function for smoothly communicating between a plurality of hardware and software components.

The communication module may be configured to include at least one software component for processing data items transmitted and received through a communication system or an external port.

The graphic module may be configured to include at least one software component configured to provide and display graphics on a display unit.

The user interface module may be configured to include at least one software component related to a user interface.

The camera module may be configured to include camera-related software components capable of performing camera-related processes and functions.

The application module may be configured to include a software component for at least one application program installed in the electronic device.

The processor unit may be configured to include a memory interface, at least one processor, and a peripheral interface. Herein, the memory interface, the at least one processor, and the peripheral interface, which are included in the processor module, may be integrated in at least one Integrated Circuit (IC) or may be implemented as separate components.

The memory interface is configured to control access to the memory by a component such as the processor or the peripheral interface.

The peripheral interface is configured to control connections among input and output peripherals of the electronic device, the processor, and the memory interface.

The processor is configured to perform a control operation such that the electronic device is configured to provide a variety of services such as voice communication and data communication using at least one software program. Also, the processor may be configured to perform a control operation such that the electronic device may be configured to execute at least one software module stored in the memory and provides a service corresponding to an executing software module. For example, the processor may include at least one of a data processor, an image processor, and an output control processor.

The communication system is configured to process signals transmitted and received through an antenna to perform data communications. Herein, the communication system may be classified as a plurality of communication sub-modules which support different communication networks. For example, the communication network may be, but is not limited to, any one of a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a BLUETOOTH network in which BLUETOOTH is a short range wireless communications technology at the 2.4 GHz band, commercially available from the BLUETOOTH SPECIAL INTEREST GROUP, INC., a Near Field Communication (NFC) network, etc. Herein, the wireless LAN includes a tethering type network and a wireless LAN direct type network.

An audio processing unit may be configured to connect to a speaker and a microphone and may be responsible for inputting and outputting an audio stream, such as audio signals used in a voice recognition function, a voice copy function, a digital recording function, and a phone call function.

An external port may be configured to include a connection interface to be configured to connect the electronic device to an external electronic device directly or to connect the electronic device to another electronic device through a network. For example, the external port may be configured to include a Universal Serial Bus (USB) port, a High Definition Multimedia Interface (HDMI) port, a network port complying with the IEEE 1394 interface standard, etc.

An I/O control module is configured to provide an interface between input and output devices, such as the display device and the input device, and the peripheral interface.

The display unit is configured to display state information of the electronic device, characters input by a user, moving pictures, still pictures, etc. according to control of the graphic module. When the display unit is equipped with a touch screen according to one exemplary embodiment of the present invention, the display unit is configured to provide touch information of the touch screen to the processor module through the I/O control module.

An input device is configured to provide input data, generated by selection by the user, to the processor module through the I/O control module. For one example, the input device is configured to include only a control button for controlling the electronic device. For another example, the input device may be equipped with a keypad configured to receive input data from the user.

The camera system may be configured to connect to an optical sensor and may be configured to perform a function for photographing objects and generating corresponding moving picture data and still picture data.

A motion sensor and the optical sensor may connect to the peripheral interface and may be configured to perform several functions. For example, the motion sensor and the optical sensor may connect to the peripheral interface, may be configured to sense motion of the electronic device, and may be configured to sense light from outside of the electronic device. Furthermore, a position measurement system and other sensors such as a temperature sensor, a bio-sensor, etc. may connect to the peripheral interface and may be configured to perform related functions.

1. An electronic device comprising:
a memory; and
at least one processor coupled to the memory configured to:
receive a request from a host user to create a car pool event including reward information; and
transmit information pertinent to the car pool event to at least one participant user.

2. The electronic device of claim 1, wherein the at least one processor is further configured to:
receive input of at least one category associated with the car pool event and associate the at least one category with an account of the host user.

3. The electronic device of claim 1, wherein the at least one processor is further configured to:
receive input of a mode of operation to specify whether a user is either requesting a ride or offering a ride.

4. The electronic device of claim 1, wherein the at least one processor is further configured to:
transmit a current geographic location of a host user;
receive input of at least one announcement of a car pool request from at least one participant user located in the current geographic location of the host user; and
display, in map format, the at least one announcement of a car pool request.

5. The electronic device of claim 1, wherein the at least one processor is further configured to:
receive at least one request announcement comprising location and distance of at least one other nearby participant user.

6. The electronic device of claim 1, wherein the at least one processor is further configured to:
provide access to a profile of a host user and a participant user.

7. The electronic device of claim 1, wherein the at least one processor is further configured to:
receive input of a valid start location and a valid end location for the car pool event.

8. The electronic device of claim 1, wherein the at least one processor is further configured to:
receive input of a valid start day and a valid end day for the car pool event.

9. The electronic device of claim 1, wherein the at least one processor is further configured to:
display updates and changes to the car pool event in real time.

10. The electronic device of claim 1, wherein the at least one processor is further configured to:
receive input, from the host user, of a request of fulfillment of at least one role by at least one participant user.

11. The electronic device of claim 1, wherein the at least one processor is further configured to:
display a quick-start menu configured to enable a host user to create a car pool event.

12. The electronic device of claim 1, wherein the at least one processor is further configured to:
enable a host user to exchange at least one message with at least one participant user.

13. The electronic device of claim 1, wherein the at least one processor is further configured to:
generate a group reference number configured to enable access to at least one profile of at least one participant user.

14. The electronic device of claim 1, wherein the at least one processor is further configured to:
provide a token of appreciation to the at least one participant user and offer an amount of credit to the at least one participant user.

15. The electronic device of claim 1, wherein the at least one processor is further configured to:
enable a communication exchange of users within a car pool group.

16. The electronic device of claim 1, wherein the request further includes at least one input of departure time information, return time information, location information, and participant user role information.

17. A method comprising:
receiving a request from a host user to create a car pool event including reward information; and
transmitting information pertinent to the car pool event to at least one participant user.

18. The method of claim 17, further comprising:
receiving input of at least one category associated with the car pool event and associating the at least one category with an account of the host user.

19. The method of claim 17, further comprising:
receiving input of a mode of operation to specify whether a user is either requesting a ride or offering a ride.

20. The method of claim 17, further comprising:
transmitting a current geographic location of a host user;
receiving input of at least one announcement of a car pool request from at least one participant user located in the current geographic location of the host user; and
displaying, in map format, the at least one announcement of a car pool request.

21. The method of claim 17, further comprising:
receiving at least one request announcement comprising location and distance of at least one other nearby participant user.

22. The method of claim 17, further comprising:
providing access to a profile of a host user and a participant user.

23. The method of claim 17, further comprising:
receiving input of a valid start location and a valid end location for the car pool event.

24. The method of claim 17, further comprising:
receiving input of a valid start day and a valid end day for the car pool event.

25. The method of claim 17, further comprising:
displaying updates and changes to the car pool event in real time.

26. The method of claim 17, further comprising:
receiving input, from the host user, of a request of fulfillment of at least one role by at least one participant user.

27. The method of claim 17, further comprising:
displaying a quick-start menu configured to enable a host user to create a car pool event.

28. The method of claim 17, further comprising:
enabling a host user to exchange at least one message with at least one participant user.

29. The method of claim 17, further comprising:
generating a group reference number configured to enable access to at least one profile of at least one participant user.

30. The method of claim 17, further comprising:
providing a token of appreciation to the at least one participant user and offer an amount of credit to the at least one participant user.

31. The method of claim 17, further comprising:
enabling a communication exchange of users within a car pool group.

32. The method of claim 17, wherein the request further includes at least one input of departure time information, return time information, location information, and participant user role information.

33. A computer-readable storage medium storing one or more programs comprising instructions which, when executed by an electronic device, cause the device to execute the method according to claim 17.

34. A system comprising:
a plurality of electronic devices in communication with a server;
wherein a request from a host electronic device to create a car pool event including reward information is received by the server and transmitted to other electronic devices.
